(19) United States
(12) Patent Application Publication
(10) Pub. No.: US 2023/0067039 A1
(43) Pub. Date: Mar. 2, 2023

(54) INFORMATION PROCESSING APPARATUS, INFORMATION PROCESSING METHOD, AND INFORMATION PROCESSING PROGRAM

(71) Applicant: FUJIFILM CORPORATION, Tokyo (JP)

(72) Inventors: Yutaka OISHI, Tokyo (JP); Michitaka KONDO, Tokyo (JP); Misaki OTSUKA, Tokyo (JP); Yuko MASUDA, Tokyo (JP)

(21) Appl. No.: 17/815,945

(22) Filed: Jul. 29, 2022

(30) Foreign Application Priority Data
Sep. 1, 2021 (JP) 2021-142679

(51) Int. Cl. G06F 3/06

(52) U.S. Cl. CPC G06F 3/0647; G06F 3/0682; G06F 3/0604

(57) ABSTRACT

An information processing apparatus determines a data migration timing of a magnetic tape as a data migration source based on a transition of information related to pieces of valid data included in a data group recorded in each of a plurality of the magnetic tapes, and performs control of migrating the pieces of valid data recorded in the magnetic tape as a data migration source to a magnetic tape as a data migration destination at the determined timing.

### CROSS-REFERENCE TO RELATED APPLICATIONS

The present application claims priority under 35 U.S.C. § 119 to Japanese Patent Application No. 2021-142679 filed on Sep. 1, 2021. The above application is hereby expressly incorporated by reference, in its entirety, into the present application.

### BACKGROUND

### 1. Technical Field

The present disclosure relates to an information processing apparatus, an information processing method, and an information processing program.

### 2. Description of the Related Art

JP2008-146408A discloses a technique of migrating only pieces of valid data among pieces of valid data and invalid data recorded in a magnetic tape to another magnetic tape in a case where an amount of pieces of invalid data recorded in a magnetic tape is equal to or larger than a threshold value.

### SUMMARY

However, in the technique described in JP2008-146408A, an amount of pieces of invalid data at a preset timing is used as a data migration timing, and as a result, data migration is not always performed at an appropriate timing.

An object of the present disclosure is to provide an information processing apparatus, an information processing method, and an information processing program capable of performing data migration at an appropriate timing.

According to an aspect of the present disclosure, there is provided an information processing apparatus including: at least one processor, in which the processor is configured to determine a data migration timing of a magnetic tape as a data migration source based on a transition of information related to pieces of valid data included in a data group recorded in each of a plurality of the magnetic tapes, and perform control of migrating the pieces of valid data recorded in the magnetic tape as a data migration source to a magnetic tape as a data migration destination at the determined timing.

In the information processing apparatus according to the aspect of the present disclosure, the information related to pieces of valid data may be the number of the pieces of valid data.

Further, in the information processing apparatus according to the aspect of the present disclosure, the information related to pieces of valid data may be a total value of sizes of the pieces of valid data.

Further, in the information processing apparatus according to the aspect of the present disclosure, the information related to pieces of valid data may be a statistic value of access frequencies to the pieces of valid data.

Further, in the information processing apparatus according to the aspect of the present disclosure, the processor may be configured to determine, as the data migration timing, a timing at which a change in the information related to pieces of valid data per unit time is within a certain range.

Further, according to another aspect of the present disclosure, there is provided an information processing method executed by a processor of an information processing apparatus, the method including: determining a data migration timing of a magnetic tape as a data migration source based on a transition of information related to pieces of valid data included in a data group recorded in each of a plurality of the magnetic tapes; and performing control of migrating the pieces of valid data recorded in the magnetic tape as a data migration source to a magnetic tape as a data migration destination at the determined timing.

Further, according to still another aspect of the present disclosure, there is provided an information processing program for causing a processor of an information processing apparatus to execute a process including: determining a data migration timing of a magnetic tape as a data migration source based on a transition of information related to pieces of valid data included in a data group recorded in each of a plurality of the magnetic tapes; and performing control of migrating the pieces of valid data recorded in the magnetic tape as a data migration source to a magnetic tape as a data migration destination at the determined timing.

According to the present disclosure, it is possible to perform data migration at an appropriate timing.

### BRIEF DESCRIPTION OF THE DRAWINGS

FIG. 1 is a block diagram illustrating an example of a configuration of an information processing system.

FIG. 2 is a block diagram illustrating an example of a hardware configuration of an information processing apparatus.

FIG. 3 is a diagram illustrating an example of a tape management table.

FIG. 4 is a diagram for explaining invalid data.

FIG. 5 is a block diagram illustrating an example of a functional configuration of the information processing apparatus.

FIG. 6 is a graph illustrating an example of a time-series transition of the number of pieces of valid data.

FIG. 7 is a diagram for explaining data migration processing.

FIG. 8 is a flowchart illustrating an example of data migration processing.

FIG. 9 is a diagram for explaining data migration processing according to a modification example.

### DETAILED DESCRIPTION

Hereinafter, an example of an embodiment for performing a technique according to the present disclosure will be described in detail with reference to the drawings.

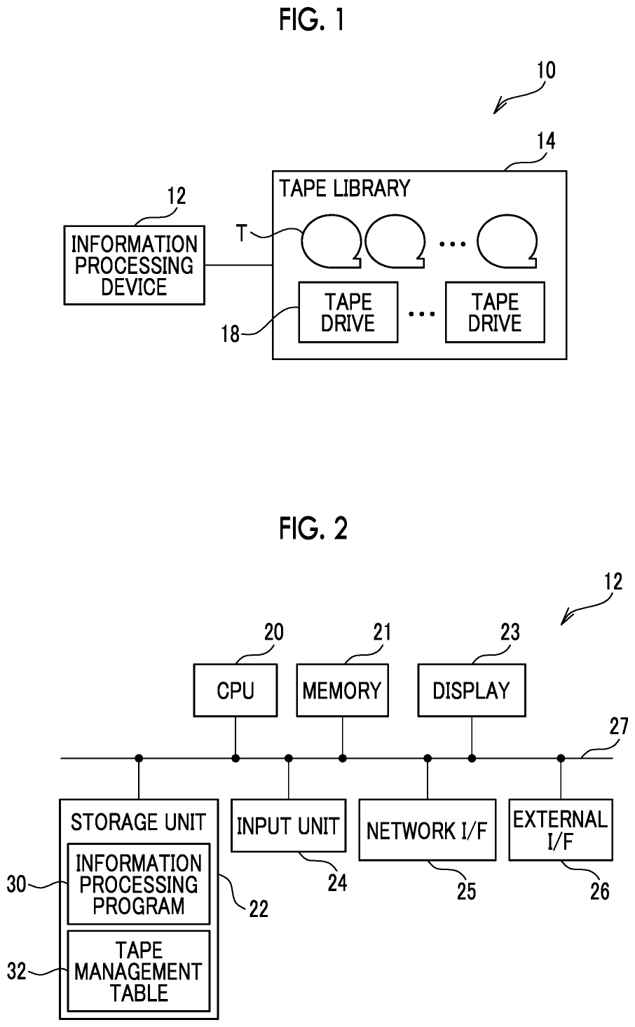

First, a configuration of an information processing system 10 according to the present embodiment will be described with reference to FIG. 1. As illustrated in FIG. 1, the information processing system 10 includes an information processing apparatus 12 and a tape library 14. Examples of the information processing apparatus 12 include a server computer and the like.

The tape library 14 includes a plurality of slots (not illustrated) and a plurality of tape drives 18, and each slot includes a magnetic tape T as an example of a recording medium. Each tape drive 18 is connected to the information processing apparatus 12. The tape drive 18 writes or reads data to or from the magnetic tape T under a control of the information processing apparatus 12. Examples of the magnetic tape T include a linear tape-open (LTO) tape.

In a case where the information processing apparatus 12 writes or reads data to or from the magnetic tape T, the magnetic tape T as a write target or a read target is loaded from the slot into a predetermined tape drive 18. In a case where data is written or read to and from the magnetic tape T loaded into the tape drive 18, the magnetic tape T is unloaded from the tape drive 18 into the slot in which the magnetic tape T is originally included.

Next, a hardware configuration of the information processing apparatus 12 according to the present embodiment will be described with reference to FIG. 2. As illustrated in FIG. 2, the information processing apparatus 12 includes a central processing unit (CPU) 20, a memory 21 as a temporary memory area, and a non-volatile storage unit 22. Further, the information processing apparatus 12 includes a display 23 such as a liquid crystal display, an input device 24 such as a keyboard and a mouse, a network interface (I/F) 25 connected to a network, and an external I/F 26 to which each tape drive 18 is connected. The CPU 20, the memory 21, the storage unit 22, the display 23, the input device 24, the network I/F 25, and the external I/F 26 are connected to a bus 27.

The storage unit 22 is realized by a hard disk drive (HDD), a solid state drive (SSD), a flash memory, or the like. An information processing program 30 is stored in the storage unit 22 as a storage medium. The CPU 20 reads the information processing program 30 from the storage unit 22, develops the read information processing program 30 in the memory 21, and executes the developed information processing program 30.

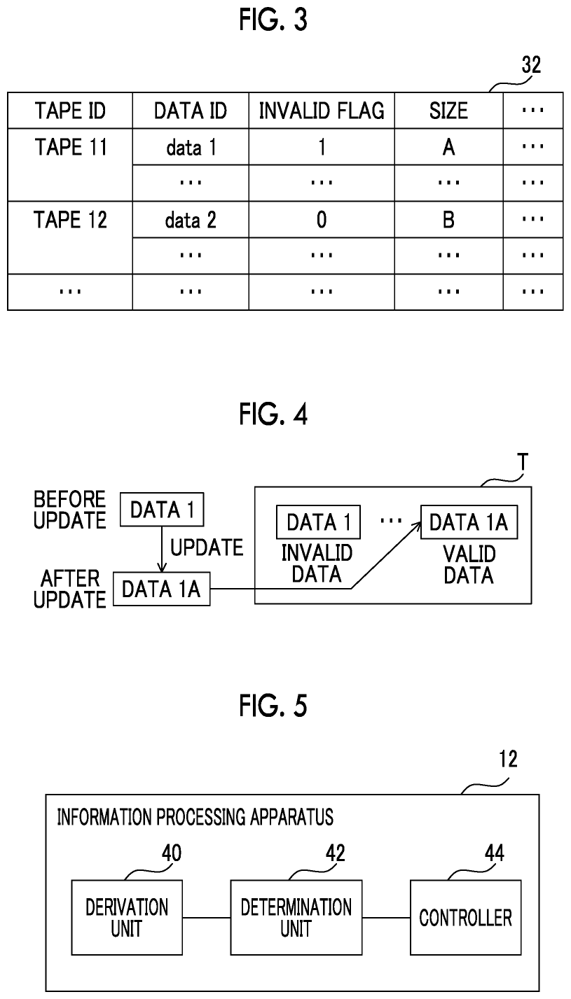

Further, the storage unit 22 stores a tape management table 32 for managing the magnetic tape T. FIG. 3 illustrates an example of the tape management table 32. As illustrated in FIG. 3, the tape management table 32 includes a tape identifier (ID) which is an example of identification information of the magnetic tape T and a data ID which is an example of identification information of the data recorded in the magnetic tape T. Further, the tape management table 32 stores information indicating whether the data indicated by the data ID is invalid data or valid data and a size of the data. In the present embodiment, in a case where the data is invalid data, “1” is stored in the invalid flag column, and in a case where the data is valid data, “0” is stored in the invalid flag column.

The invalid data is, for example, data for which a deletion instruction is input by the user and which is logically deleted. In order to physically delete the data for which the deletion instruction is input by the user from the magnetic tape T, all pieces of data recorded in the magnetic tape T are temporarily saved in another storage area, the magnetic tape T is initialized, and pieces of data excluding the logically-deleted data among all pieces of the saved data are recorded in the magnetic tape T. For this reason, in order to physically delete the data from the magnetic tape T, the tape drive 18 is occupied for a relatively long time. Therefore, in the present embodiment, the data for which the deletion instruction is input by the user is logically deleted by storing “1” in the invalid flag column of the tape management table 32. Thereby, the data will not be accessed by the user.

Further, as an example, as illustrated in FIG. 4, in the present embodiment, data updated by the user is not overwritten in the magnetic tape T, but the updated data is newly recorded in the magnetic tape T. In this case, the data before update that is recorded in the magnetic tape T will not be accessed by the user. Therefore, the invalid data may be the data before update that is no longer accessed by the user due to update. In addition, the invalid data may be both logically-deleted data and data before update. Further, the valid data means data other than the invalid data, that is, data that may be accessed by the user.

Next, a functional configuration of the information processing apparatus 12 according to the present embodiment will be described with reference to FIG. 5. As illustrated in FIG. 5, the information processing apparatus 12 includes a derivation unit 40, a determination unit 42, and a controller 44. In a case where the CPU 20 executes the information processing program 30, the information processing apparatus 12 functions as the derivation unit 40, the determination unit 42, and the controller 44.

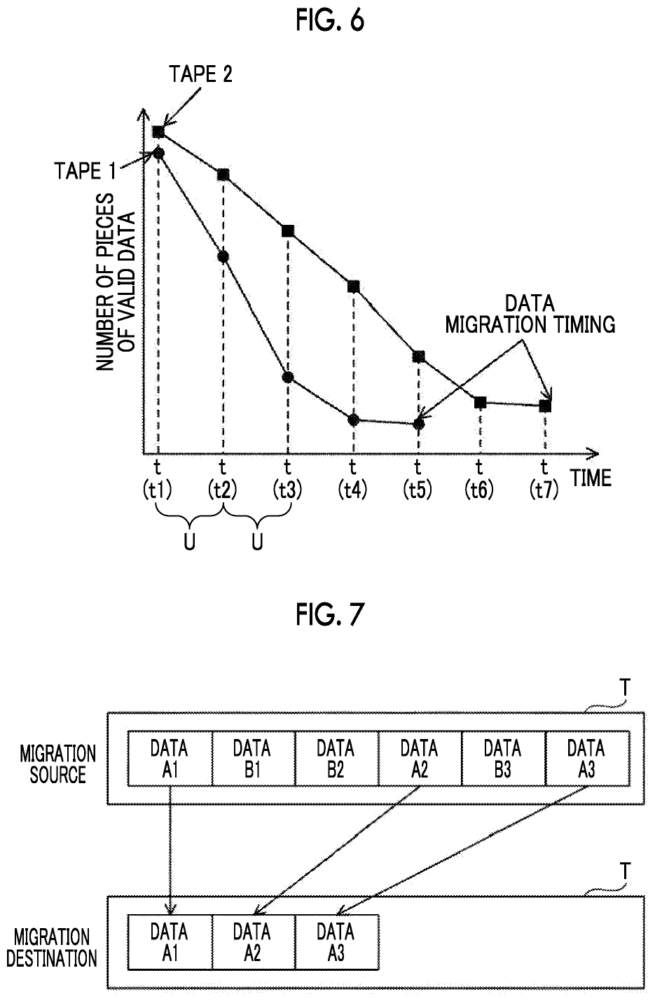

The derivation unit 40 derives information related to pieces of valid data included in a data group recorded in each of a plurality of magnetic tapes Ts as data migration sources. Specifically, the derivation unit 40 derives the number of pieces of valid data as information related to pieces of valid data recorded in a magnetic tape T, for each magnetic tape T as a data migration source, by referring to the tape management table 32. As an example, as illustrated in FIG. 6, the derivation unit 40 derives the number of pieces of valid data for each magnetic tape T as a data migration source at a timing t for each unit time U. In the following, in a case of distinguishing the timing tin FIG. 6, a number is added at the end.

FIG. 6 illustrates an example in which the derivation unit 40 derives the number of pieces of valid data for each of two magnetic tapes Ts. The plurality of magnetic tapes Ts as data migration sources may be all the magnetic tapes Ts included in the tape library 14, or may be magnetic tapes Ts satisfying a condition which is preset as a data migration condition. Examples of the magnetic tapes Ts satisfying a data migration condition in this case include a magnetic tape T that is used for a certain period or longer, a magnetic tape T on which reading and writing are performed a certain number of times or more, a magnetic tape T of which an error rate in reading and writing is equal to or higher than a certain value, and the like.

Further, in the present embodiment, a case where the unit time U is constant will be described. On the other hand, the present invention is not limited to thereto. For example, in a period of time for which an access frequency from a user is relatively low such as at night, the unit time U may be longer than in a period of time for which an access frequency from a user is relatively high such as daytime. Further, for example, the unit time U may be shortened as the access frequency increases in a certain period of time.

The determination unit 42 determines a data migration timing of the magnetic tape T as a data migration source based on a transition of the number of pieces of valid data that is derived by the derivation unit 40 for each of the plurality of magnetic tapes Ts. In the present embodiment, the determination unit 42 determines, as the data migration timing, a timing at which a change in the number of pieces of valid data per unit time U is within a certain range. Specifically, the determination unit 42 derives, as a change in the number of pieces of valid data per unit time U, a difference between the number of pieces of valid data at a timing t and the number of pieces of valid data at an immediately preceding timing t for each timing t. The determination unit 42 determines, as a data migration timing, a timing t at which the difference is within a certain range. Examples of the certain range in this case include a range of ±10% of the number of pieces of valid data at the immediately preceding timing t.

In the example of FIG. 6, a timing t5 is determined as a data migration timing for a magnetic tape “tape 1”, and a timing t7 is determined as a data migration timing for a magnetic tape “tape 2”. For example, in a case where a deletion instruction of data is input from a user terminal (not illustrated), the data is logically deleted from the magnetic tape T in which the data is recorded. In the present embodiment, in an invalid flag column of the tape management table 32, an invalid flag corresponding to the data is updated from “0” to “1”. That is, the number of pieces of valid data recorded in the magnetic tape T is decreased by 1, and the number of pieces of invalid data is increased by 1. In a case where data migration is performed at a timing at which the number of pieces of valid data continues to decrease, there is a relatively high possibility that the number of pieces of valid data continues to decrease even in a magnetic tape T as a data migration destination. In this case, the number of pieces of invalid data continues to increase in the magnetic tape T as a data migration destination, and thus data migration is performed again at a relatively short time interval. Therefore, in the present embodiment, the determination unit 42 determines, as a data migration timing, a timing at which a change in the number of pieces of valid data per unit time U is within a certain range.

In a case where a magnetic tape T as a data migration source that is determined by the determination unit 42 as being at a data migration timing exists at each timing t, the controller 44 performs control of migrating data from the magnetic tape T to a magnetic tape T as a data migration destination. Specifically, the controller 44 performs control of reading all pieces of data recorded in a magnetic tape T as a data migration source. Next, as an example, as illustrated in FIG. 7, the controller 44 performs control of recording, in a magnetic tape T as a data migration destination, pieces of valid data among all pieces of data obtained by the control by referring to the tape management table 32, and discards the invalid data. In the present embodiment, as the magnetic tape T as a data migration destination, for example, a magnetic tape T in which data is not recorded, such as an unused magnetic tape T or a magnetic tape T immediately after initialization, is used. FIG. 7 illustrates an example in which pieces of data A1 to A3 are valid data and pieces of data B1 to B3 are invalid data. Here, the control by the controller 44 includes transmitting a data migration instruction to an apparatus to be controlled by the information processing apparatus 12, such as the tape drive 18.

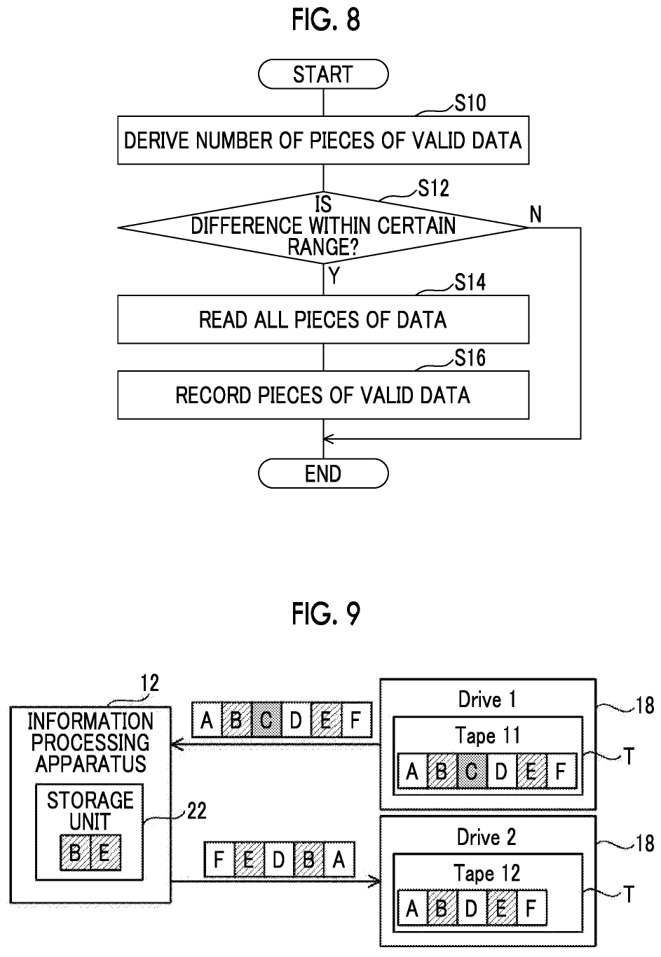

Next, an operation of the information processing apparatus 12 according to the present embodiment will be described with reference to FIG. 8. In a case where the CPU 20 executes the information processing program 30, data migration processing illustrated in FIG. 8 is executed. The data migration processing illustrated in FIG. 8 is executed, for example, at a periodic timing such as every unit time U. Further, the data migration processing illustrated in FIG. 8 is executed by using, as a processing target, each of the plurality of magnetic tapes Ts as data migration sources.

In step S10 of FIG. 8, as described above, the derivation unit 40 derives the number of pieces of valid data in a data group recorded in a magnetic tape T as a data migration source. In step S12, the determination unit 42 derives a difference between the number of pieces of valid data that is derived in step S10 and the number of pieces of valid data that is derived in step S10 when data migration processing is executed last time. The determination unit 42 determines whether or not the derived difference is within a certain range. In a case where the determination unit 42 determines that the derived difference is within a certain range, that is, in a case where the determination unit 42 determines a data migration timing, a determination result in step S12 is Yes, and the process proceeds to step S14.

In step S14, the controller 44 performs control of reading all pieces of data recorded in a magnetic tape T as a data migration source. In step S16, the controller 44 performs control of recording, in a magnetic tape T as a data migration destination, pieces of valid data among all pieces of data obtained by the control in step S14 by referring to the tape management table 32, and discards the invalid data. In a case where the processing of step S16 is completed, data migration processing is completed.

On the other hand, in a case where the determination unit 42 determines that the derived difference is not within a certain range, that is, in a case where the determination unit 42 does not determine a data migration timing, a determination result in step S12 is No. In this case, processing of step S14 and processing of step S16 are not executed, and the data migration processing is ended.

In a case where data migration is performed in the data migration processing, the controller 44 may perform control of initializing the magnetic tape T as a data migration source. In this case, the initialized magnetic tape T can be reused. Further, in a case where data migration is performed in the data migration processing, the controller 44 may perform control of unloading the magnetic tape T as a data migration source from the tape library 14. In this case, a new magnetic tape T can be included in the tape library 14 instead of the unloaded magnetic tape T.

As described above, according to the present embodiment, it is possible to perform data migration at an appropriate timing.

In the above embodiment, a case where the number of pieces of valid data is applied as information related to pieces of valid data recorded in a magnetic tape T has been described. On the other hand, the present disclosure is not limited thereto. For example, a total value of sizes of pieces of valid data may be applied as information related to pieces of valid data recorded in a magnetic tape T. Further, for example, a statistic value of access frequencies to the pieces of valid data may be applied as information related to pieces of valid data recorded in a magnetic tape T. Examples of the statistic value in this case include an average value, a maximum value, a median value, and the like. Further, for example, information related to pieces of invalid data recorded in a magnetic tape T may be used. Examples of the information include the number of pieces of invalid data, a total value of sizes of pieces of invalid data, and the like.

Further, in the above embodiment, as an example, as illustrated in FIG. 9, in data migration, the controller 44 may temporarily store, in a storage device such as the memory 21 or the storage unit 22 having a higher transmission speed than that of the magnetic tape T, pieces of valid data of which the access frequencies are equal to or higher than a threshold value, among pieces of valid data read from the magnetic tape T as a data migration source. FIG. 9 illustrates an example in which pieces of data A to F are pieces of data recorded in a magnetic tape T as a data migration source, pieces of data A, B, D, E, and F are pieces of valid data, and data C is invalid data. Further, FIG. 9 illustrates an example in which, among pieces of data A, B, D, E, and F, pieces of data B and E are pieces of valid data of which the access frequencies are equal to or higher than a threshold value, and pieces of data A, D, and F are pieces of valid data of which the access frequencies are lower than the threshold value. In this case, even during a period for which data migration is being performed, it is possible to shorten a response time to an access from a user to the data having a relatively high access frequency.

Further, in the embodiment, for example, as a hardware structure of a processing unit that executes various processing such as the derivation unit 40, the determination unit 42, and the controller 44, the following various processors may be used. The various processors include, as described above, a CPU, which is a general-purpose processor that functions as various processing units by executing software (program), and a dedicated electric circuit, which is a processor having a circuit configuration specifically designed to execute a specific processing, such as a programmable logic device (PLD) or an application specific integrated circuit (ASIC) that is a processor of which the circuit configuration may be changed after manufacturing such as a field programmable gate array (FPGA).

One processing unit may be configured by one of these various processors, or may be configured by a combination of two or more processors of the same type or different types (for example, a combination of a plurality of FPGAs or a combination of a CPU and an FPGA). Further, the plurality of processing units may be configured by one processor.

As an example in which the plurality of processing units are configured by one processor, firstly, as represented by a computer such as a client and a server, a form in which one processor is configured by a combination of one or more CPUs and software and the processor functions as the plurality of processing units may be adopted. Secondly, as represented by a system on chip (SoC) or the like, a form in which a processor that realizes the function of the entire system including the plurality of processing units by one integrated circuit (IC) chip is used may be adopted. As described above, the various processing units are configured by using one or more various processors as a hardware structure.

Further, as the hardware structure of the various processors, more specifically, an electric circuit (circuitry) in which circuit elements such as semiconductor elements are combined may be used.

Further, in the embodiment, an example in which the information processing program 30 is stored (installed) in the storage unit 22 in advance has been described. On the other hand, the present disclosure is not limited thereto. The information processing program 30 may be provided by being recorded in a recording medium such as a compact disc read only memory (CD-ROM), a digital versatile disc read only memory (DVD-ROM), or a Universal Serial Bus (USB) memory. Further, the information processing program 30 may be downloaded from an external apparatus via a network.

What is claimed is:

1. An information processing apparatus comprising:
at least one processor,
wherein the processor is configured to
determine a data migration timing of a magnetic tape as a data migration source based on a transition of information related to pieces of valid data included in a data group recorded in each of a plurality of the magnetic tapes, and
perform control of migrating the pieces of valid data recorded in the magnetic tape as a data migration source to a magnetic tape as a data migration destination at the determined timing.

2. The information processing apparatus according to claim 1,
wherein the information is the number of the pieces of valid data.

3. The information processing apparatus according to claim 1,
wherein the information is a total value of sizes of the pieces of valid data.

4. The information processing apparatus according to claim 1,
wherein the information is a statistic value of access frequencies to the pieces of valid data.

5. The information processing apparatus according to claim 1,
wherein the processor is configured to determine, as the data migration timing, a timing at which a change in the information per unit time is within a certain range.

6. The information processing apparatus according to claim 2,
wherein the information is a total value of sizes of the pieces of valid data.

7. The information processing apparatus according to claim 2,
wherein the information is a statistic value of access frequencies to the pieces of valid data.

8. The information processing apparatus according to claim 3,
wherein the information is a statistic value of access frequencies to the pieces of valid data.

9. The information processing apparatus according to claim 6,
wherein the information is a statistic value of access frequencies to the pieces of valid data.

10. The information processing apparatus according to claim 2,
wherein the processor is configured to determine, as the data migration timing, a timing at which a change in the information per unit time is within a certain range.

11. The information processing apparatus according to claim 3,
wherein the processor is configured to determine, as the data migration timing, a timing at which a change in the information per unit time is within a certain range.

12. The information processing apparatus according to claim 4,
wherein the processor is configured to determine, as the data migration timing, a timing at which a change in the information per unit time is within a certain range.

13. The information processing apparatus according to claim 6,
wherein the processor is configured to determine, as the data migration timing, a timing at which a change in the information per unit time is within a certain range.

14. The information processing apparatus according to claim 7,
wherein the processor is configured to determine, as the data migration timing, a timing at which a change in the information per unit time is within a certain range.

15. The information processing apparatus according to claim 8,
wherein the processor is configured to determine, as the data migration timing, a timing at which a change in the information per unit time is within a certain range.

16. The information processing apparatus according to claim 9,
wherein the processor is configured to determine, as the data migration timing, a timing at which a change in the information per unit time is within a certain range.

17. An information processing method executed by a processor of an information processing apparatus, the method comprising:
determining a data migration timing of a magnetic tape as a data migration source based on a transition of information related to pieces of valid data included in a data group recorded in each of a plurality of the magnetic tapes; and
performing control of migrating the pieces of valid data recorded in the magnetic tape as a data migration source to a magnetic tape as a data migration destination at the determined timing.

18. A non-transitory computer-readable storage medium storing an information processing program for causing a processor of an information processing apparatus to execute a process comprising:
determining a data migration timing of a magnetic tape as a data migration source based on a transition of information related to pieces of valid data included in a data group recorded in each of a plurality of the magnetic tapes; and
performing control of migrating the pieces of valid data recorded in the magnetic tape as a data migration source to a magnetic tape as a data migration destination at the determined timing.
